(19) United States
(12) Patent Application Publication
(10) Pub. No.: US 2018/0172833 A1
(43) Pub. Date: Jun. 21, 2018

(54) LASER REPEATER

(71) Applicant: Kevin N. Pyle, Highlands Ranch, CO (US)

(72) Inventor: Kevin N. Pyle, Highlands Ranch, CO (US)

(21) Appl. No.: 15/399,486

(22) Filed: Jan. 5, 2017

Related U.S. Application Data
(60) Provisional application No. 62/437,026, filed on Dec. 20, 2016.

(51) Int. Cl. G01S 17/89; G01S 7/481; G01S 17/10

(52) U.S. Cl. CPC G01S 17/89; G01S 7/4814; G01S 17/10; G01S 7/4817; G01S 7/4816

(57) ABSTRACT

Systems and methods for remote sensing. In one implementation, the system includes an overhead reflector, a ground-based laser, and an overhead sensor. The ground-based laser directs a beam to the overhead reflector. The overhead reflector reflects at least some of the beam to the ground, and at least some of the light from the beam reaching the ground reflects from the ground. The overhead sensor detects at least some of the light reflected from the ground. The system may be monostatic or bistatic, and may include a lidar sensor, for three dimensional mapping of a target area.

### CROSS REFERENCE TO RELATED APPLICATIONS

This application claims the benefit of Provisional U.S. Patent Application No. 62/437,026 filed Dec. 20, 2016 and titled “Laser Repeater”, the entire disclosure of which is hereby incorporated by reference herein for all purposes

### BACKGROUND OF THE INVENTION

Lidar is a versatile technique for three dimensional measurement. For example, airborne lidar may be used for terrain mapping, as shown in FIG. 1.

In the example of FIG. 1, aircraft 101 carries a laser and a light detector, along with a mechanism for “scanning” the beam of the laser across the flight path on the ground. For example, the beam may be reflected from a steerable mirror. A global positioning system (GPS) receiver 102 measures the position of aircraft 101, and other instruments monitor the attitude 103 of aircraft 101 during flight. A nearby GPS ground reference 104 may be used to improve the accuracy of the GPS coordinates measured by GPS receiver 102.

Pulses of light from the laser are directed sequentially toward the ground in an array pattern in relation to aircraft 101. The direction of each beam in relation to aircraft 101, along with the measured GPS 102 coordinates and attitude 103 of aircraft 101, characterize the locations of the laser beam paths 105 in three-dimensional space.

When one of beams 105 strikes the ground or an object on the ground, some of the laser light is reflected back toward aircraft 101, where it is detected. The time of flight of the respective laser pulse allows computation of the distance traveled by each pulse. From the beam position and distance travelled, the coordinates of the point in three-dimensional space from which the beam was reflected can be determined. For example, in FIG. 1, particular beam 106 reflects from point 107 on the ground, while particular beam 108 reflects from point 109 on a rooftop 110.

The “point cloud” made up by the collective coordinates of the points of reflection of the beams 105 from the ground or other objects characterizes the surface topography, and can be used for display and analysis. While only a sparse array of points is shown in FIG. 1, other systems may generate a denser array of points, for higher resolution characterization of the surface.

In the system of FIG. 1, the laser (including its power source), the scanning mechanism, and the sensor are all airborne. The performance of the system is generally a function of the amount of laser power that can be generated and directed to the ground. Performance may be limited by considerations of the size, weight, and power (SWaP) of components that can be carried by aircraft 101. SWaP considerations may be especially limiting in satellite-based lidar systems, such as those used for environmental research and other applications. Besides the expense and difficulty of placing powerful laser systems into earth orbit, the high-power solid-state lasers being developed for these applications may degrade in power output over time, degrading overall system performance, with little opportunity for service or repair.

Similar difficulties arise in designing low-cost small-area lidar systems, for example systems to be carried by unmanned aerial vehicles (UAVs) or “drones”. Drone payload size restrictions imposed by Federal Aviation Administration (FAA) rules Part 107 effectively limit the size and power of the lasers that can be carried.

### BRIEF SUMMARY OF THE INVENTION

According to one aspect, a system comprises an overhead reflector, a ground-based laser, and an overhead sensor. The ground-based laser directs a beam to the overhead reflector. The overhead reflector reflects at least some of the beam to a target area. At least some of the light from the beam reaching the target area reflects from the target area. The overhead sensor detects at least some of the light reflected from the target area.

### BRIEF DESCRIPTION OF THE DRAWINGS

FIG. 1 illustrates a conventional lidar system used for surface mapping.

FIG. 2 illustrates a system in accordance with embodiments of the invention.

FIG. 3 shows a bistatic system in accordance with embodiments of the invention.

FIG. 4 illustrates a generalized monostatic system, in accordance with embodiments of the invention.

FIG. 5 shows a monostatic system in accordance with embodiments of the invention, using an aircraft as the overhead platform.

FIG. 6 shows a monostatic system in accordance with embodiments of the invention, using a satellite as the overhead platform.

FIG. 7 illustrates a system in accordance with embodiments of the invention, using a simple pole-mounted sensor and steerable reflector.

FIG. 8 illustrates a generalized bistatic system, in accordance with embodiments of the invention.

FIG. 9 shows a bistatic system in accordance with embodiments of the invention, using a UAV as the first overhead platform.

FIG. 10 shows a bistatic system in accordance with embodiments of the invention, using an aircraft as the first overhead platform.

FIG. 11 shows a bistatic system in accordance with embodiments of the invention, using a satellite as the first overhead platform.

FIG. 12 shows a bistatic system in accordance with embodiments of the invention, using a first satellite as the first overhead platform and a second satellite as the second overhead platform.

FIG. 13 shows a bistatic system in accordance with embodiments of the invention, using an aircraft as the first overhead platform and a satellite as the second overhead platform.

FIG. 14 shows a bistatic system in accordance with embodiments of the invention, using a satellite as the first overhead platform and an aircraft as the second overhead platform.

FIG. 15 shows a bistatic system in accordance with embodiments of the invention, using a simple pole-mounted steerable reflector and a pole-mounted sensor.

FIG. 16 shows a system in accordance with another embodiment of the invention.

FIG. 17 shows a system in accordance with embodiments of the invention, using flash lidar.

FIG. 18 shows a bistatic system in accordance with embodiments of the invention, in which an overhead reflector is carried on a satellite, and a flash lidar camera is carried on a UAV.

FIG. 19 shows a bistatic system in accordance with embodiments of the invention, including a capability for messaging embedded in lidar data.

### DETAILED DESCRIPTION OF THE INVENTION

Embodiments of the invention generate a laser signal at one location and reflect the signal to a second location using an overhead reflector. Light reflected from the second location is detected by a sensor placed at a location separate from the laser. For example, the detector may be co-located with the overhead reflector, or may be at a different overhead location.

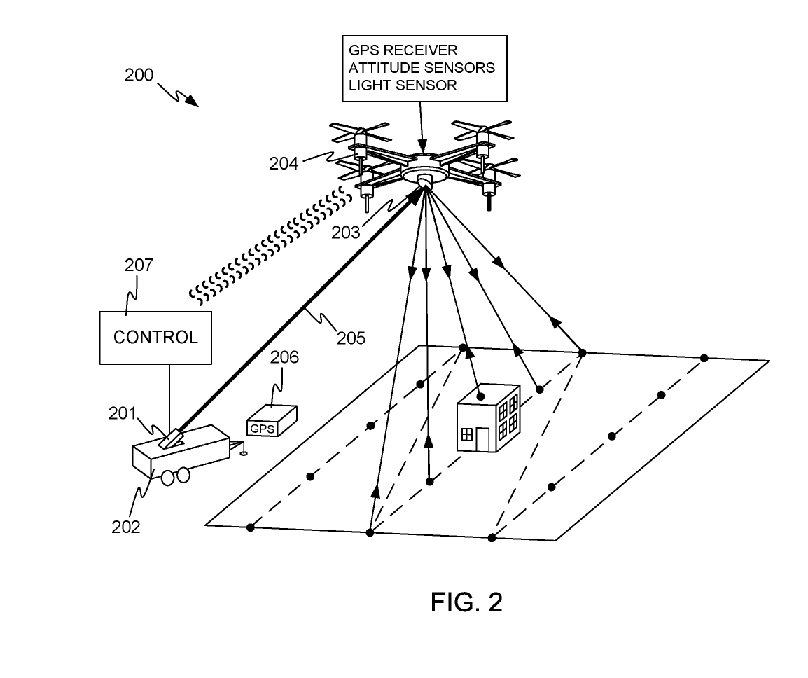

FIG. 2 illustrates a system 200 in accordance with embodiments of the invention. System 200 comprises a ground-based laser 201. Laser 201 may be any suitable type of laser operating at any suitable wavelength. Laser 201 is preferably and “eye-safe” laser. “Eye safe” may be defined either by practice, standard (e.g., ANSI) or statute (e.g., FAA, FCC, etc. regulation) and traditionally meant to refer to emissions longer than 1.4 μm in savelength. Wavelengths in this region are often called “eye-safe”, because light in that wavelength range is strongly absorbed in the eye's cornea and lens and therefore cannot reach the significantly more sensitive retina. In some embodiments, laser 201 may be, for example, a Nd:YAG laser operating at a wavelength of 1.57 μm, or may be another suitable kind of laser.

In addition or as an alternative to laser 201 being eye safe, precautions may be taken to direct laser 201 away from human piloted aircraft or overhead structures (e.g., satellites) that are not meant to be targeted or within the intercept region of emanation, either directly or by expected reflection.

Because laser 201 is ground-based, its power output is not limited by the size and weight limitations that might be present if laser 201 were to be airborne. For example, laser 201 may be mounted on a vehicle with substantial weight-carrying capacity, and may be accompanied by an electrical generator if necessary. In the example of FIG. 2, laser 201 is mounted to a trailer 202. In other embodiments, laser 201 may be mounted on a truck, boat, ship, or another conveyance. In other embodiments, laser 201 may be supported on a tripod. In smaller scale embodiments, laser 201 may be transportable by a person. In certain embodiments, laser 201 source may require the use of a telescope (sometimes referred to as an observatory) for increased power, direction (pointing) and/or directivity purposes.

System 200 also includes an overhead reflector 203. In this example, overhead reflector 203 is mounted on an unmanned aerial vehicle (UAV) or “drone” 204. Reflector 203 may be, for example a fast steering mirror carried by UAV 204. Beam 205 from laser 201 is directed toward reflector 203. UAV 204 may include a tracking target, for example a corner cube retroreflector that, in conjunction with a quadrature receiver and appropriate controls near laser 201, enables laser 201 to track UAV 204 so that beam 205 consistently strikes reflector 203.

UAV 204 also preferably carries a GPS receiver, attitude sensors, a light sensor, and appropriate control electronics. The control electronics control the angular position of reflector 203 to reflect beam 205 in a sweeping pattern onto the ground. If reflector 203 is a steerable mirror, then it may be moved in relation to UAV 204. In other embodiments, reflector 203 may be fixed in relation to UAV 204, and the reflected beam may be steered by changing the position and attitude of UAV 204. In some embodiments, reflector 203 may be an array of small steerable mirrors. In some embodiments, the reflected beam is steered by a combination of motion of reflector 203 with respect to UAV 204 and position and attitude adjustments of UAV 204 itself. A GPS ground reference 206 may be used to improve the accuracy of the GPS coordinates measured by the GPS receiver in UAV 204.

In the embodiment of FIG. 2, UAV 204 also includes a light sensor, for detecting the reflections of pulses from laser 201 from the ground. Thus, UAV 204 measures the time of receipt of the reflected pulses. UAV 204 may also detect the time at which each pulse of laser 201 strikes reflector 203, and in that case, UAV 204 can also measure the time of flight of each laser pulse from reflector 203 to the ground and back. In other embodiments UAV 204 may carry a clock synchronized with a clock at laser 201, and may simply report the time of receipt of each ground-reflected pulse. Preferably, a master controller 207 is in communication with laser 201 and UAV 204, and coordinates the motion of UAV 204 and reflector 203, the timing of pulses from laser 201, and collection of time of flight data, for computing the underlying ground topography.

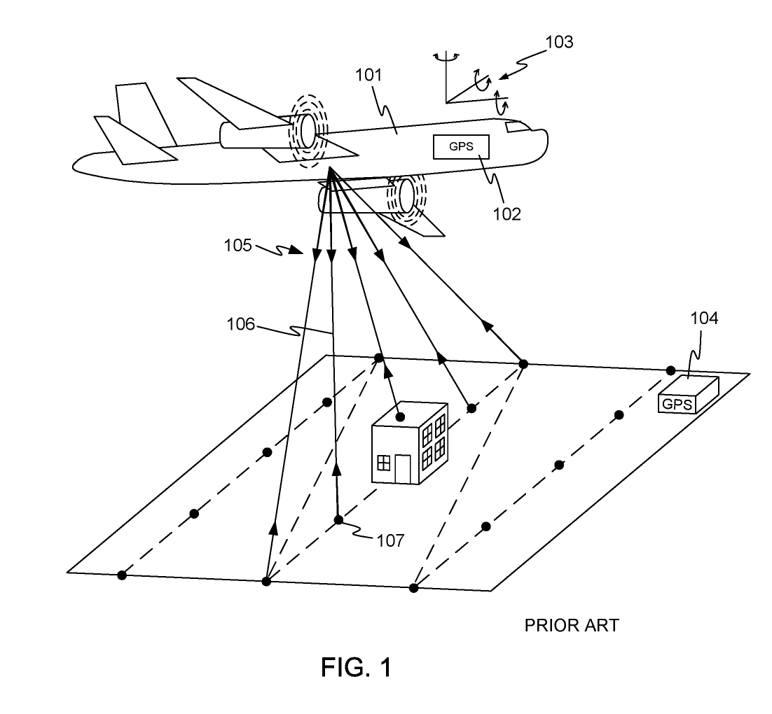

As compared with the prior airplane-based system of FIG. 1, system 200 may require that much less weight be maintained aloft, and may not require expensive aircraft time.

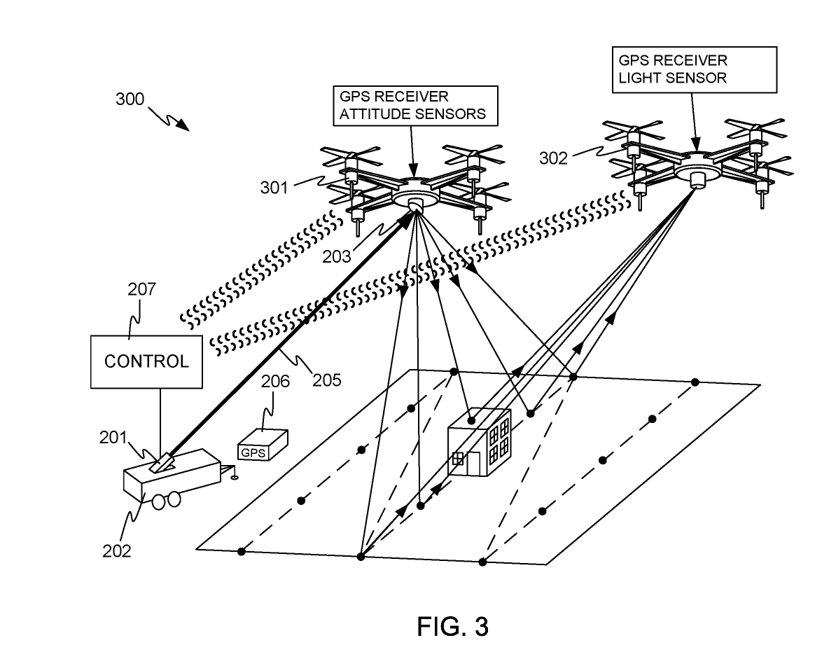

The example system if FIG. 2 is known as a “monotstatic” system, because reflector 203 and the detector for the reflected pulses are co-located on UAV 204. FIG. 3 shows a “bistatic” system 300, having the reflector and detector on separate platforms, in accordance with embodiments of the invention. System 300 may use a laser 201 and other components similar to those in system 200 described above, but uses two UAVs 301 and 302. UAV 301 carries reflector 203, and directs pulses from laser 201 in a pattern toward the ground. UAV 302 detects the reflected pulses and reports their arrival time. Controller 207 coordinates the activities of laser 201 and UAVs 301 and 302, and may calculate the ground topography from the positions of UAVs 301 and 302, the direction of each pulse reflected from reflector 203, and the time of flight of each pulse from UAV 301 to UAV 302.

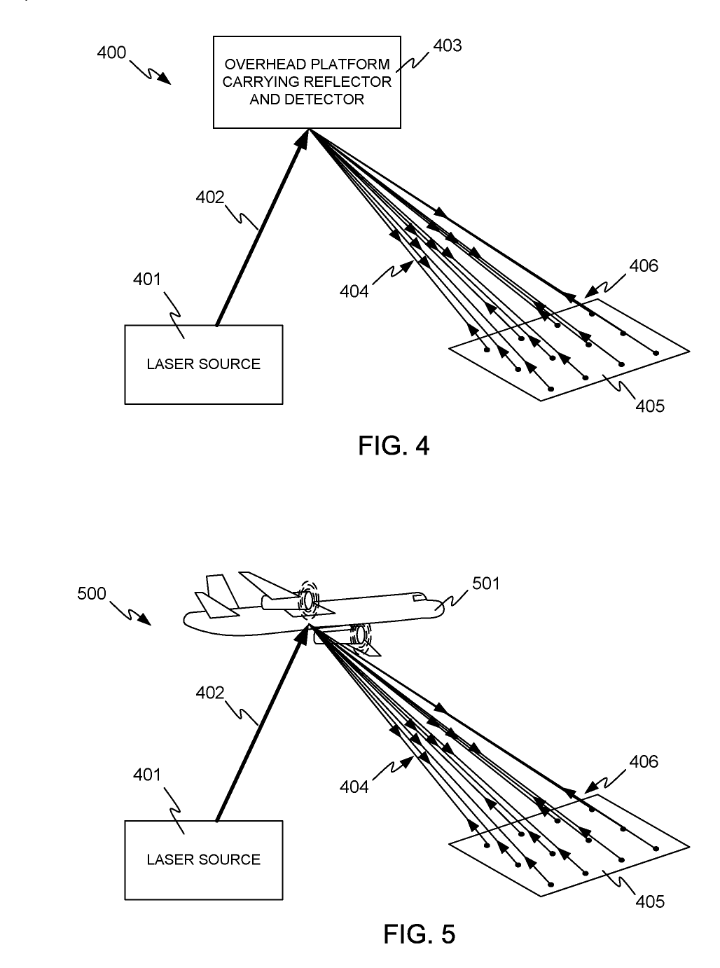

While both system 200 and 300 use UAVs as platforms for the overhead reflector and overhead light sensor, other kinds of platforms are possible. For example, FIG. 4 illustrates a generalized monostatic system 400, in accordance with embodiments of the invention. In the system of FIG. 4, a ground-based laser 401 directs a beam 402 to a reflector on an overhead platform 403. Pulsed beams 404 are directed in a pattern to a target area 405 on the ground, from which light 406 reflects. Some of the light 406 reflects back to platform 403, where it is detected. A controller and communication signals (not shown) coordinate the direction and timing of the pulses, so that the position in space of pulsed beams 404 is known and the time of flight of light from platform 403 to the ground and back is measured. From this information, the point cloud representing the ground topography can be constructed. In other embodiments, a target area may not be on the ground. For example, the target area may be on a rooftop or other location.

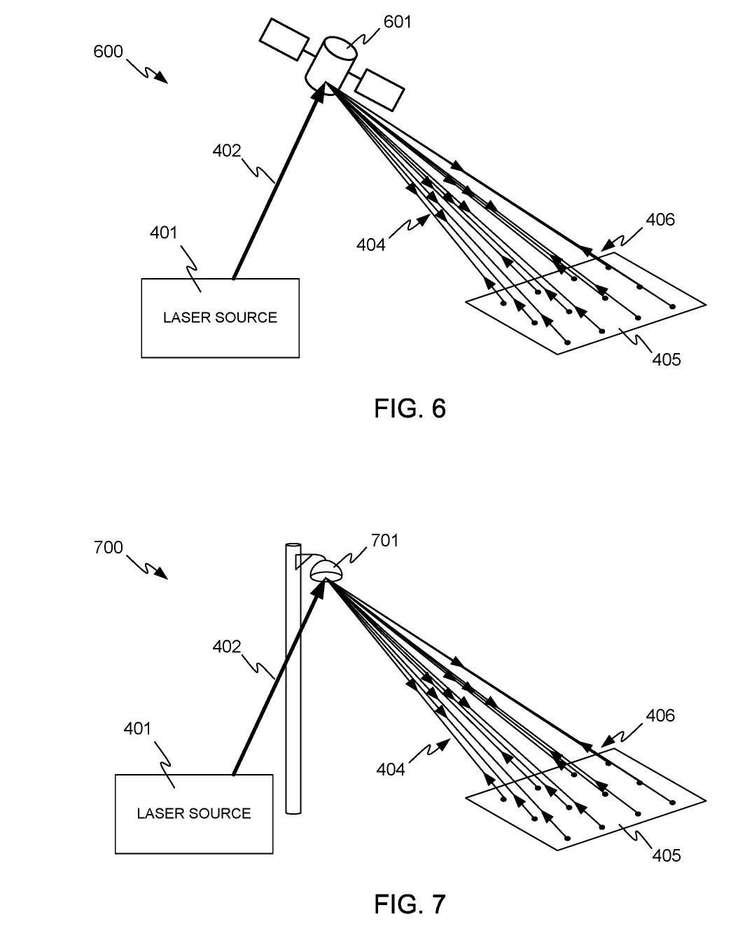

It will be recognized that system 200 shown in FIG. 2 is a specific embodiment of generalized system 400 shown in FIG. 4, with system 200 using UAV 204 as the overhead platform. In other example embodiments, different kinds of platforms may be used. For example, FIG. 5 shows a monostatic system 500 in accordance with embodiments of the invention, using an aircraft 501 as the overhead platform. (Other components are given the same reference numbers as in FIG. 4.) In another example, FIG. 6 shows a monostatic system 600 in accordance with embodiments of the invention, using a satellite 601 as the overhead platform. Satellite 601 may be in low earth orbit, geosynchronous orbit, a highly elliptical orbit, or another suitable kind of orbit. If laser 401 operates in infrared (IR) wavelengths, satellite 601 may be part of a Space-Based Infrared System (SBIR).

In other embodiments, other kinds of overhead platforms may be used, for example a manned or unmanned dirigible, a manned or unmanned blimp, a helicopter, a balloon, or another kind of overhead platform. In some embodiments, one or both platforms may be tethered to the ground, for example when a dirigible, blimp, or balloon is used.

In some applications, for example for surveillance of property, the overhead platform may be a simple as a pole, a tower, or part of a building or the like overlooking the area to be monitored. FIG. 7 illustrates a system 700 in accordance with embodiments of the invention, using a simple pole-mounted steerable reflector 701 and sensor.

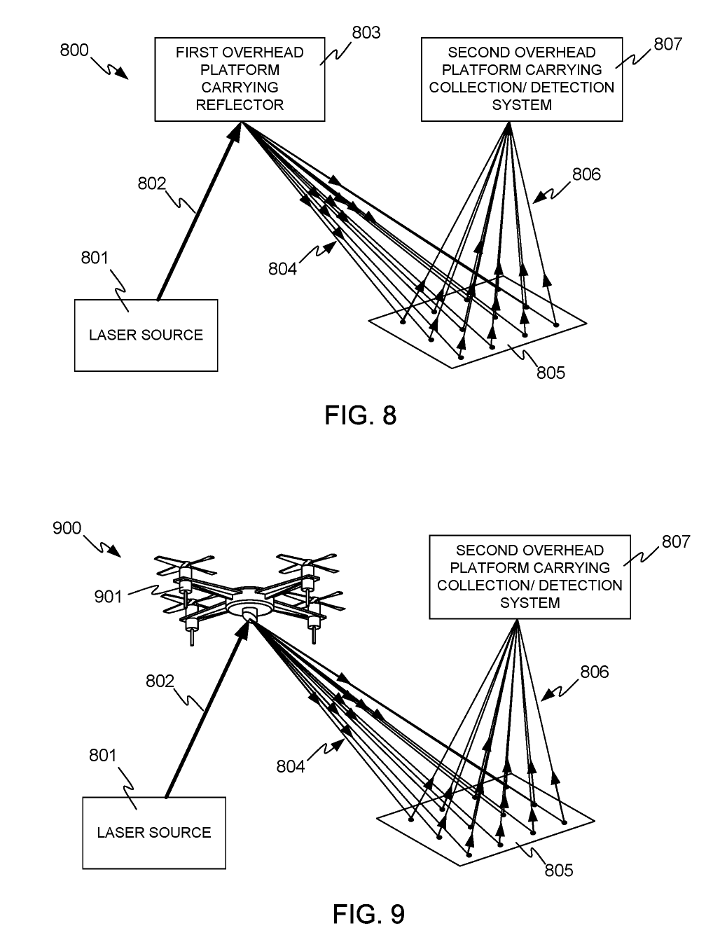

FIG. 8 illustrates a generalized bistatic system 800, in accordance with embodiments of the invention. In the system of FIG. 8, a ground-based laser 801 directs a beam 802 to a reflector on a first overhead platform 803. Pulsed beams 804 are directed in a pattern to a target area 805 on the ground, from which light 806 reflects. A detector on a second platform 807 receives the light 806 reflected from the ground. A controller and communication signals (not shown) coordinate the direction and timing of the pulses, so that the position in space of pulsed beams 804 is known and the time of flight of light from platform 803 to the ground and to second platform 807 is measured.

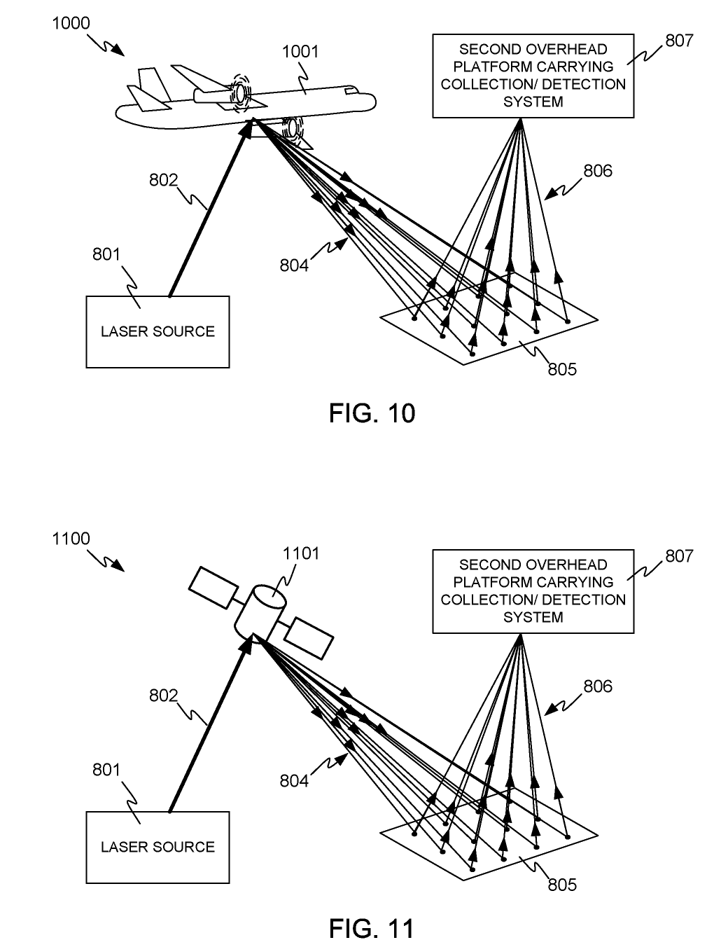

It will be recognized that system 300 shown in FIG. 3 is a specific embodiment of generalized system 800 shown in FIG. 8, with system 300 using UAVs 301 and 302 as the first and second overhead platforms. In other example embodiments, different kinds of platforms may be used. For example, FIG. 9 shows a bistatic system 900 in accordance with embodiments of the invention, using a UAV 901 as the first overhead platform. (Other components are given the same reference numbers as in FIG. 8.) In another example, FIG. 10 shows a bistatic system 1000 in accordance with embodiments of the invention, using an aircraft 1001 as the first overhead platform. FIG. 11 shows a bistatic system 1100 in accordance with embodiments of the invention, using a satellite 1101 as the first overhead platform. Satellite 1101 may be in low earth orbit, geosynchronous orbit, a highly elliptical orbit, or another suitable kind of orbit.

Other kinds of first overhead platforms may be used, for example a manned or unmanned dirigible, a manned or unmanned blimp, a helicopter, a balloon, or another kind of overhead platform. In some embodiments, the first overhead platform may simply be a pole, a tower, or part of a building or the like. In some embodiments, one or both platforms may be tethered to the ground, for example when a dirigible, blimp, or balloon is used.

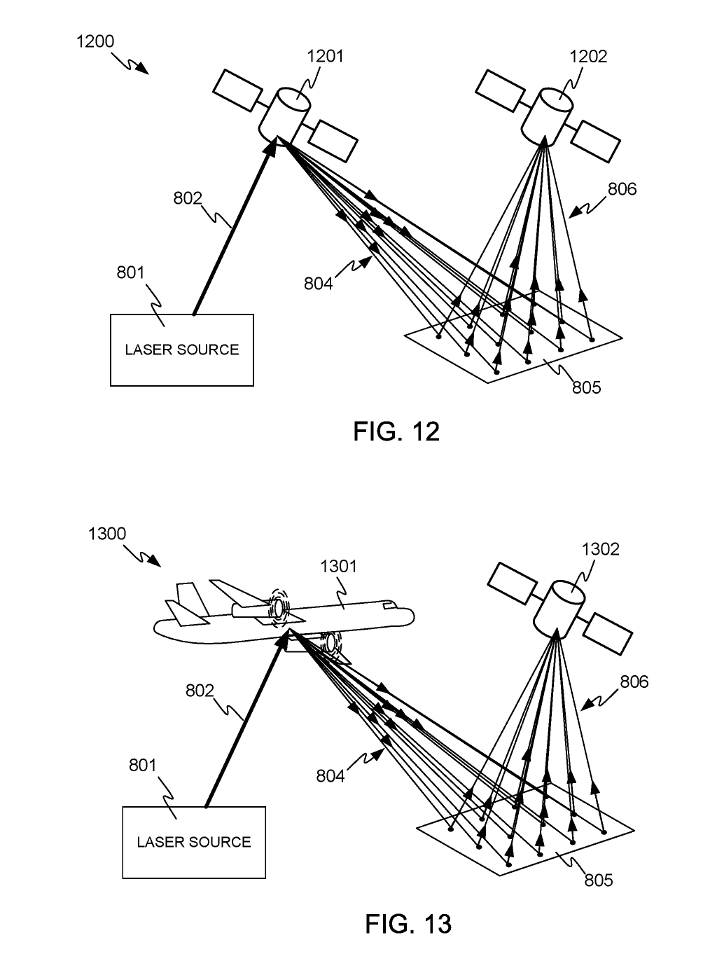

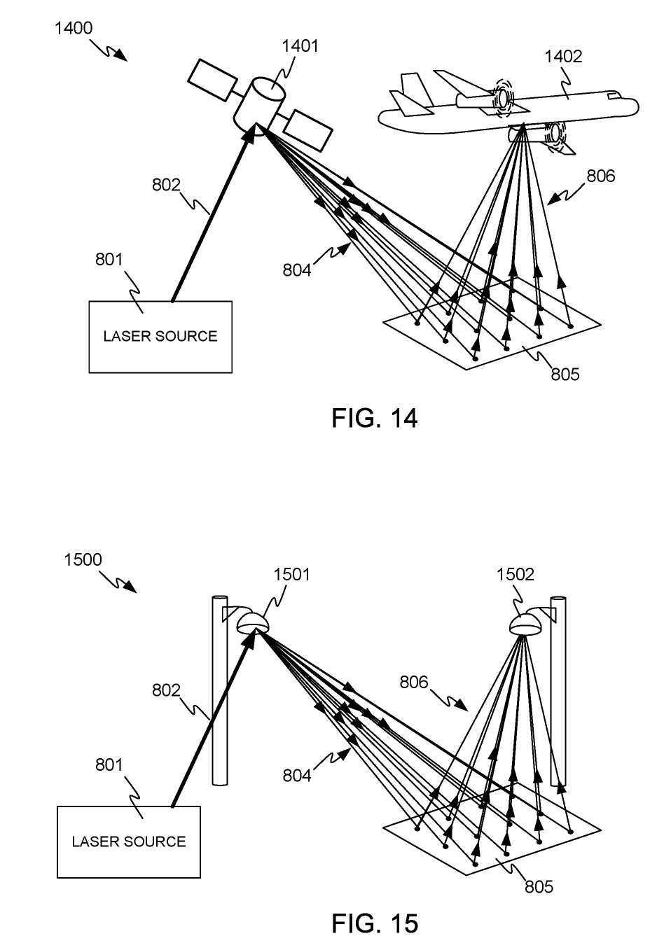

The second overhead platform may be any kind of overhead platform workable in combination with the type of first overhead platform being used. For example, FIG. 12 shows a bistatic system 1200 in accordance with embodiments of the invention, using a first satellite 1201 as the first overhead platform and a second satellite 1202 as the second overhead platform. (Other components are given the same reference numbers as in FIG. 8.) FIG. 13 shows a bistatic system 1300 in accordance with embodiments of the invention, using an aircraft 1301 as the first overhead platform and a satellite 1302 as the second overhead platform. FIG. 14 shows a bistatic system 1400 in accordance with embodiments of the invention, using a satellite 1401 as the first overhead platform and an aircraft 1402 as the second overhead platform.

In some embodiments, the second overhead platform may simply be a pole, a tower, or part of a building or the like. FIG. 15 shows a bistatic system 1500 in accordance with embodiments of the invention, using a simple pole-mounted steerable reflector 1501 and a pole-mounted sensor 1502.

In some embodiments, either or both of the laser and the overhead reflector may be fixed or steerable. For example, in system 200 shown in FIG. 2, laser 201 may be steerable to follow UAV 204, and reflector 203 may be steerable to aim the pulsed beams toward the ground in the desired pattern. Alternatively, laser 201 may be fixed, and UAV 204 may maintain its position to intercept laser beam 205, using steerable reflector 203 to direct the reflected beams to the ground in the desired pattern.

In other embodiments, the steerability of the laser source may be used to create the scanning pattern on the ground. For example, in system 700 shown in FIG. 7, reflector 701 may be fixed, and laser 401 may be steerable to reflect from different locations on reflector 701, creating the scanning pattern in target area 405. This arrangement allows reflector 701 to be completely fixed and does not require that any power or control circuitry be supplied to reflector 701.

In other embodiments, both the laser and the overhead reflector may be fixed, as is described in more detail below.

In some embodiments, the overhead reflector may comprise individually steerable reflector segments, for example an array of micromirrors. This arrangement may enable a single overhead reflector to work with multiple overhead detectors, to map or monitor multiple areas.

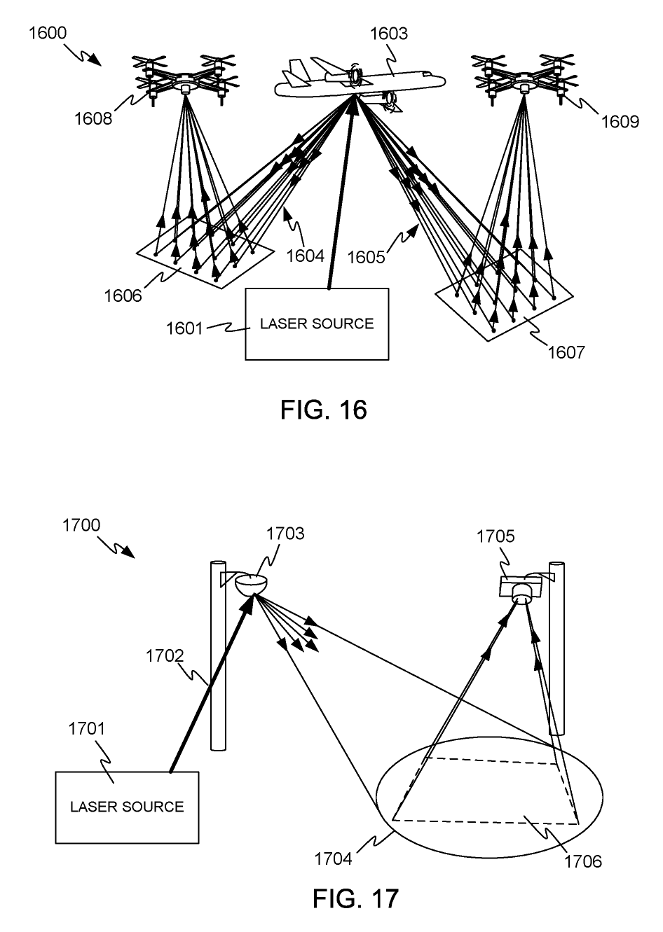

FIG. 16 shows a system 1600 in accordance with an embodiment of this arrangement.

In example system 1600, a laser 1601 sends a beam 1602 to a reflector mounted on aircraft 1603 (although any suitable platform may be used for carrying the reflector). Different portions of the reflector direct beams 1604 and 1605 to respective target areas 1606 and 1607. The target areas 1606 and 1607 are monitored by separate detectors, which in this example are mounted to separate UAVs 1608 and 1609. Any suitable platforms may be used for carrying the separate detectors, and the two detectors may be carried on different kinds of platforms. Each of the receivers may be synchronized and controlled in concert with laser source 1601 by a controller (not shown).

In some embodiments, for example in the embodiment of FIG. 16 in which independently-steerable reflectors are available, the system may be used to provide one or more pathways for point-to-point optical communication between various locations from which the reflector is viewable. For example, some or all of the reflector may be angled such that light coming from one particular point on or above the ground is directed to another particular point on or above the ground. Parties at the two points may then communicate via encoded light pulses at high speed. Such communications are difficult to intercept, due to their direct nature. In some embodiments, multiple communication paths may be provided, among multiple parties. Such communication may be provided simultaneously with using part of the reflector for sensing applications, or at a different time. If the reflector is carried on a moving platform, the reflector may be continually re-aimed so that any established communication paths are maintained during motion of the reflector platform.

All of the systems described thus far use pulsed laser beams sequentially directed in a pattern toward the target area, and the time of flight of each pulse is measured by a detector that need only detect the pulses and the time of their receipt. This technique is a form of “lidar”, which is generically the use of light to perform ranging in a similar fashion to RADAR. Lidar and variations of it may sometimes be called LADAR, LiDAR, LIDAR, Laser-RADAR, Laser Illuminated Detection and Ranging, Light Detection and Ranging, or may be called by other terms. Such terms, abbreviations, and acronyms are often used interchangeably in the related industry, and it is to be understood that embodiments of the invention may use any variation of lidar by whatever name. For example, embodiments of the invention may use direct detect, coherent detection, or any derivative thereof, or may use communications lasers and receivers.

The scanning lidar arrangement described above uses a simple sensor, but requires accurate timing and aiming of the pulses and coordination between the source, reflector, and sensor. In other embodiments, the system control requirements may be simplified by using a technique called “flash” lidar. Flash lidar uses a lens to form an image of the target area on a specially-designed array sensor. A target area is flood illuminated by one or more pulses of light of the appropriate wavelength. Each pixel in the array sensor measures the time of arrival of light reflected from the target area to the respective pixel. By virtue of the imaging function of the lens, each pixel also corresponds to a particular viewing direction from the sensor to the target area. Thus, the data collected by the sensor allows reconstruction of the three-dimensional locations of the scene locations imaged by the array sensor. The viewing direction of each pixel is determined by the pixel's location in the sensor, and the distance to objects in the scene is measured by the time of flight of the laser illumination to and from the objects at each pixel location. No scanning of the laser across the target area is needed. Flash lidar cameras are available from Advanced Scientific Concepts LLC of Santa Barbara, Calif., USA and other sources.

FIG. 17 shows a system 1700 in accordance with embodiments of the invention, using flash lidar. System 1700 is a bistatic system using simple pole-mounted platforms, but it is to be understood that a flash lidar system may be used with any workable combination of platforms, and may be used in a monostatic system.

In example system 1700, a laser 1701 directs a beam 1702 to an overhead reflector 1703. Reflector 1703 may be, for example, a simple convex mirror or other optical element that reflects beam 1702 in a diverging manner to cast a pool of light 1704 on the target area. A camera 1705 has a field of view 1706, at least some of which falls within the illuminated area 1704. In some embodiments, camera 1705 may be a conventional camera that simply captures images of some or all of the target area. However, in other embodiments, camera 1705 may be a flash lidar camera. In this embodiment, once laser 1701 is aimed at reflector 1703, no steering of either laser 1701 or reflector 1703 is necessary. The entire target area may be illuminated by a single pulse from laser 1702.

Lidar control and communication may also be simplified in system 1700, as compared with system 1500 or other scanning systems. In system 1700, the controller (not shown) need only know the position of reflector 1703, the position and orientation of camera 1705, and the starting time of the illumination pulse in order to compute the three-dimensional locations of ground features, given the pulse time of arrival measurements provided by each camera pixel.

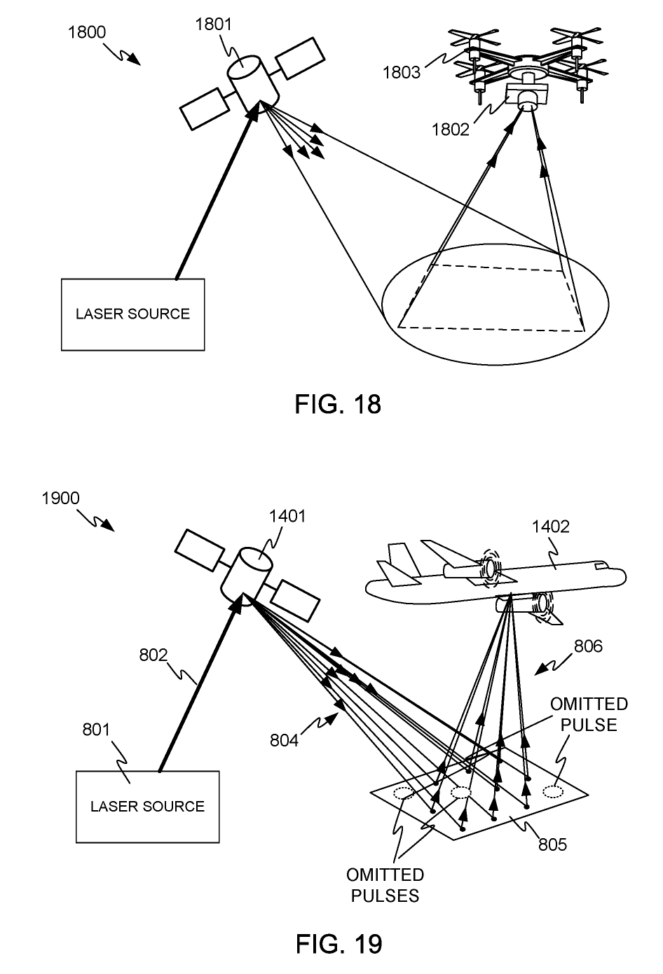

FIG. 18 shows a bistatic system 1800 in accordance with embodiments of the invention, in which an overhead reflector is carried on a satellite 1801, and the flash lidar camera 1802 is carried on a UAV 1803. Many other combinations of platform types are possible. When the overhead reflector is carried on a moving platform, for example a satellite or aircraft, the laser may track the reflector as described above, and the reflector may be steerable at least to the extent necessary to direct the reflected laser pulses to the target area.

FIG. 19 shows a bistatic system 1900 in accordance with embodiments of the invention, including a capability for messaging embedded in the lidar data. Example system 1900 is similar to system 1400 shown in FIG. 14, in that it uses a satellite 1401 as the platform for carrying the overhead reflector, and an aircraft 1402 for carrying the sensor. Any other combination of platforms may be used.

In the example of FIG. 19, several pulses of the scanned laser have been omitted. The pattern of the omitted pulses may be selected to communicate specified information, the encoding of which is previously agreed upon with the receiver. For the purposes of lidar sensing, the missing pulse data may be ignored, may be interpolated from nearby measurements, a scan line having a missing pulse may be repeated with all pulses present, or the missing data may be handled in some other way. In other embodiments, the embedded messaging may be accomplished in other ways. For example, certain beam pulses may be provided using a different laser wavelength than the other pulses, so that the encoded message may be reconstructed from the pulses detected in the messaging wavelength.

In the claims appended hereto, the term “a” or “an” is intended to mean “one or more.” The term “comprise” and variations thereof such as “comprises” and “ comprising,” when preceding the recitation of a step or an element, are intended to mean that the addition of further steps or elements is optional and not excluded. The invention has now been described in detail for the purposes of clarity and understanding. However, those skilled in the art will appreciate that certain changes and modifications may be practiced within the scope of the appended claims.

What is claimed is:

1. A system, comprising:
an overhead reflector;
a ground-based laser; and
an overhead sensor;
wherein the ground-based laser directs a beam to the overhead reflector;
and wherein the overhead reflector reflects at least some of the beam to a target area;
and wherein at least some of the light from the beam reaching the target area reflects from the target area;
and wherein the overhead sensor detects at least some of the light reflected from the target area.

2. The system of claim 1, wherein the overhead reflector comprises at least one steerable mirror.

3. The system of claim 2, wherein the overhead reflector comprises an array of steerable mirrors.

4. The system of claim 1, wherein the overhead reflector is mounted on a platform selected from the group consisting of an unmanned aerial vehicle, an aircraft, and a satellite.

5. The system of claim 1, wherein the overhead sensor is mounted on a platform selected from the group consisting of an unmanned aerial vehicle, an aircraft, and a satellite.

6. The system of claim 1, wherein the overhead sensor gathers imagery of the target area.

7. The system of claim 1, wherein the system measures the time of flight of laser pulses from the overhead reflector to the overhead sensor, and characterizes the topography of the target area based on the time of flight measurements.

8. The system of claim 7, wherein the pulses from the laser are reflected to the target area in a scanned pattern.

9. The system of claim 8, wherein information is encoded in the pattern of pulses.

10. The system of claim 7, wherein the target area is flood illuminated by light reflected from the overhead reflector, and wherein the overhead sensor is a flash lidar sensor.

11. The system of claim 1, wherein the overhead reflector and the overhead sensor are co-located.

12. The system of claim 1, wherein the overhead reflector and the overhead sensor mounted on separate platforms.

13. The system of claim 1, wherein the overhead reflector is fixed to a platform.

14. The system of claim 1, wherein the laser is steerable.

15. The system of claim 1, wherein the laser is fixed.

16. The system of claim 1, wherein:
both the reflector and the laser are fixed;
both the reflector and the laser are steerable;
the reflector is fixed and the laser is steerable; or
the reflector is steerable and the laser is fixed.

17. The system of claim 1, wherein at least a portion of the overhead reflector is further positioned to provide a pathway for light-based communication between two selected points in space.
